(19) United States
(12) Patent Application Publication
(10) Pub. No.: US 2024/0124052 A1
(43) Pub. Date: Apr. 18, 2024

(54) Pump Device for a Steering Device of a Vehicle, Steering Device, and Method and Device for Producing a Pump Device

(71) Applicant: KNORR-BREMSE Systeme fuer Nutzfahrzeuge GmbH, Muenchen (DE)

(72) Inventor: Bernhard MILLER, Weil der Stadt (DE)

(21) Appl. No.: 18/277,435

(22) PCT Filed: Jan. 24, 2022
(86) PCT No.: PCT/EP22/51491

§ 371 Date: Aug. 16, 2023

(30) Foreign Application Priority Data
Feb. 18, 2021 (DE) 10 2021 103 815.4

(51) Int. Cl. B62D 5/06

(52) U.S. Cl. CPC B62D 5/064; B62D 5/06

(57) ABSTRACT

A pump device for a steering device of a vehicle includes a pump for pumping a working medium to a first outlet connection or alternatively to a second outlet connection, an electric motor for driving the pump, and a housing, through which the first outlet connection and the second outlet connection are guided. The housing is arranged about the pump and the electric motor.

### BACKGROUND AND SUMMARY

The present disclosure relates to a pump device for a steering apparatus of a vehicle, a steering apparatus, and a method and an apparatus for producing a pump device.

In steering systems of vehicles, in particular in front axle steering systems, also called power assisted steering, of medium and heavy commercial vehicles, a recirculating ball steering gear, for example, can be operated by an external, unidirectional hydraulic pump. A connection between the pump and the steering gear can be made, for example, by external piping. An external oil reservoir may additionally be required as a compensation tank. Individual components of such a steering system can thus be arranged in a distributed manner in the vehicle.

DE 20 2019 101 522 U1 discloses a corresponding steering assistance apparatus for a vehicle, in particular for a commercial vehicle.

Against this background, the object of the present approach is to provide an improved pump device for a steering apparatus of a vehicle, an improved steering apparatus, and a method and an apparatus for producing such an improved pump apparatus.

This object is achieved by a pump device, by a steering apparatus, by a method, by an apparatus as claimed in claim 13, and by a computer program, in accordance with the independent claims.

The advantages which can be achieved with the approach that is presented are that installation space can be saved, which is also accompanied by a weight saving. Furthermore, the manufacturing costs are also lowered as a result, since less construction material is required.

There is therefore provided a pump device for a steering apparatus of a vehicle, wherein the pump device comprises a pump for pumping a working medium to a first output port or alternatively to a second output port, an electric motor for driving the pump, and a housing through which the first output port and the second output port are guided and which is arranged around the pump and the electric motor.

The steering apparatus can be used for vehicles, such as, for example, commercial vehicles. It is configured to assist a steering movement specified by a driver. The steering apparatus can be formed, for example, as a hydraulically operating steering gear. The working medium can accordingly be in the form of hydraulic oil, for example. The first output port and additionally or alternatively the second output port can be formed, for example, as an interface with a line system, which can comprise a plurality of lines in the form of hoses or pipes. The electric motor can, for example, activate the pump so that the working medium can be recirculated within the pump device. The housing can be formed, for example, as a protective casing for protecting the electric motor and the pump from external influences.

According to one embodiment, the pump can be arranged with the electric motor on a common shaft. Such an embodiment of the approach presented here offers the advantage of a particularly space-saving component, since a coupling for the shaft of the electric motor and of the pump can be avoided.

According to one embodiment, the electric motor can have a rotor having a plurality of permanent magnets, wherein mutually adjacent permanent magnets are spaced apart by slots for the passage of the working medium. The rotor can be in the form of, for example, a rotatable rotor disk, so that the construction of the pump device can be as compact as possible.

According to one embodiment, the slots can be formed to convey the working medium on rotation of the rotor. Advantageously, a uniform flow of the working medium through the slots can thus be achieved.

The electric motor can have a motor winding which is surrounded by the working medium. The motor winding can be in the form of a coil.

According to one embodiment, the housing can have a channel for guiding the working medium from an inlet along an inside wall of the housing to the motor winding. The channel can be formed to guide the working medium around the motor winding. The channel can be formed, for example, in the manner of a hose, as a groove or indentation in a housing element, or in the manner of a pipe. The inlet can denote, for example, an interface between the pump and the channel or alternatively an interface between a storage vessel and the pump device. Advantageously, by the arrangement of the channel, the motor winding can be cooled by means of working medium.

According to one embodiment, a needle bearing can be arranged on the side of the pump between the pump and the housing, and/or a ball bearing can be provided on the side of the electric motor. Advantageously, no additional motor bearings are required. As a result, very stable and inexpensive mounting of the components in question can be achieved by simple means.

According to one embodiment, the electric motor can be formed as a disk motor. Advantageously, the electric motor can thus have a flat construction, whereby installation space is saved.

According to one embodiment, the pump can be formed as a bidirectional hydraulic pump. Advantageously, simple delivery of the working medium according to the desired conveying direction of the working medium can also be achieved in this manner.

There is further provided a steering apparatus for a vehicle, which steering apparatus has a pump device in one of the variants presented here, a transmission device and a controller. The transmission device has an input shaft, which can be coupled with a steering wheel, and an output shaft, which can be coupled with a steering arm, a transmission element which is movable in a first direction and in a second direction for transmitting a torque from the input shaft to the output shaft, and a first working medium port and a second working medium port. The first working medium port is connected to the first output port for moving the transmission element in the first direction using the working medium, and the second working medium port is connected to the second output port for moving the transmission element in the second direction using the working medium. The controller is configured to provide a motor signal to the electric motor in order to operate the electric motor of the steering apparatus.

The steering apparatus can be used in a commercial vehicle, such as, for example, a truck. The transmission device can be configured, for example, to transmit the steering direction specified by a driver to vehicle wheels.

According to one embodiment, the steering apparatus can have a valve which is connected between the first output port and the second output port. The valve can be formed, for example, as a backup valve which is opened, for example, in an emergency situation or in a warm-up phase for the working medium in order, for example, to prevent a steering movement.

There is further provided a method for producing a pump device in one of the above-mentioned variants, wherein the method comprises a step of providing a pump, an electric motor and a housing, and a step of assembling the pump, the electric motor and the housing to produce the pump device.

The method can be used, for example, in the case of machine production of the pump device.

This method can be implemented, for example, in software or hardware or in a mixed form of software and hardware, for example in a controller.

The approach presented here further provides an apparatus which is configured to carry out, activate or implement the steps of a variant of a method presented here in corresponding devices. The object on which the approach is based can be achieved quickly and efficiently also by this embodiment variant of the approach in the form of an apparatus.

To that end, the apparatus can have at least one computing unit for processing signals or data, at least one memory unit for storing signals or data, at least one interface with a sensor or with an actuator for reading sensor signals from the sensor or for outputting data signals or control signals to the actuator, and/or at least one communication interface for reading or outputting data, which are embedded in a communication protocol. The computing unit can be, for example, a signal processor, a microcontroller or the like, wherein the memory unit can be a flash memory, an EPROM or a magnetic memory unit. The communication interface can be configured to read or output data wirelessly and/or by cable, wherein a communication interface which can read or output data by cable can read such data from a corresponding data transmission line or output them into a corresponding data transmission line electrically or optically, for example.

In an advantageous embodiment, a method for producing a pump device is controlled by the apparatus. To that end, the apparatus can access, for example, sensor signals such as a provision signal and an assembly signal. Activation takes place by way of actuators such as a provision unit, which is configured to provide the provision signal and/or the assembly signal.

Also advantageous is a computer program product or computer program with program code, which can be stored on a machine-readable carrier or storage medium, such as a semiconductor memory, fixed-disk storage or an optical memory, and is used to carry out, implement and/or activate the steps of the method according to one of the above-described embodiments, in particular when the program product or program is executed on a computer or on an apparatus.

Exemplary embodiments of the approach presented here will be explained in greater detail in the following description with reference to the figures.

### BRIEF DESCRIPTION OF THE DRAWINGS

FIG. 1 is a schematic representation of a vehicle having a steering apparatus according to an exemplary embodiment;

FIG. 2 is a schematic cross-sectional representation of a pump device according to an exemplary embodiment;

FIG. 3 is a flow diagram of a method for heating a working medium in a pre-heating phase for a steering apparatus according to an exemplary embodiment; and

FIG. 4 is a block diagram of an apparatus for activating a method for producing a pump device according to an embodiment.

In the following description of advantageous exemplary embodiments of the present approach, the same or similar reference signs are used for the elements shown in the various figures that have the same action, wherein a repeat description of such elements is omitted.

### DETAILED DESCRIPTION OF THE DRAWINGS

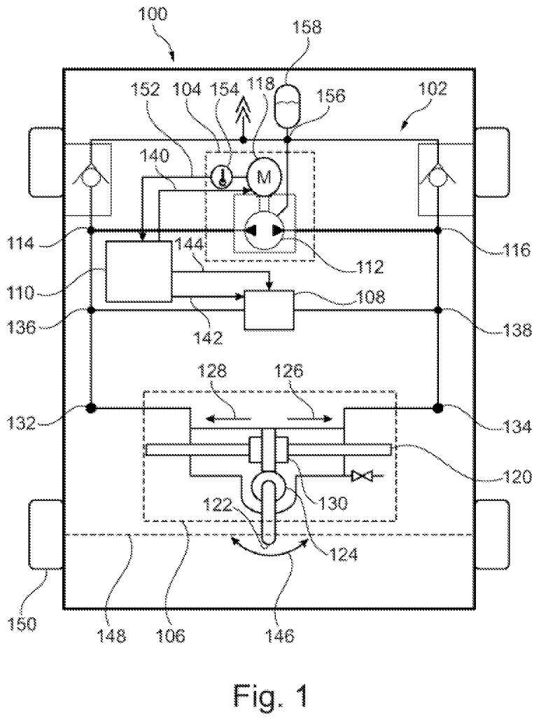

FIG. 1 shows a schematic representation of a vehicle 100 having a steering apparatus 102 according to an exemplary embodiment. The vehicle 100 can be in the form of, for example, a commercial vehicle which is configured to transport mainly objects. Since the vehicle 100 may weigh several tons, the vehicle 100 has the steering apparatus 102. The steering apparatus 102 is configured to assist an occupant of the vehicle 100, such as, for example, a driver of the vehicle 100, with a steering operation. To that end, the steering apparatus 102 has a pump device 104, a transmission device 106, a valve 108 and a controller 110. The pump device 104 comprises a pump 112 for pumping a working medium to a first output port 114 or to a second output port 116, an electric motor 118, which is configured to drive the pump 112, and a housing through which the first output port 114 and the second output port 116 are guided and which is arranged around the pump 112 and the electric motor 118. According to this exemplary embodiment, the pump 112 is arranged with the electric motor 118 on a common shaft. The electric motor 118 is according to this exemplary embodiment in the form of a disk motor. The pump 112 can be in the form of, for example, a bidirectional hydraulic pump.

The transmission device 106 has an input shaft 120, which can be coupled with a steering wheel, and an output shaft 124, which can be coupled with a steering arm 122. The transmission device 106 further has a transmission element 130 which is movable in a first direction 126 and in a second direction 128 for transmitting a torque from the input shaft 120 to the output shaft 124. The transmission device 106 further comprises a first working medium port 132 and a second working medium port 134, wherein the first working medium port 132 is connected to the first output port 114 for moving the transmission element 130 in the first direction 126 using the working medium, and the second working medium port 134 is connected to the second output port 116 for moving the transmission element 130 in the second direction 128 using the working medium. The valve 108 of the steering apparatus 102 is connected between the first output port 114 and the second output port 116. This means that the valve 108 according to this exemplary embodiment has a first valve port 136 and a second valve port 138. According to this exemplary embodiment, the first valve port 136 is arranged between the first output port 114 and the first working medium port 132. Analogously, the second valve port 138 is arranged according to this exemplary embodiment between the second output port 116 and the second working medium port 134. The steering apparatus 102 additionally has the controller 110, which is configured to provide a motor signal 140 to the electric motor 118 in order to operate the electric motor 118 of the steering apparatus 102. The controller 110 is optionally configured to provide a valve opening signal 142 for opening of the valve 108 of the steering apparatus 102 to the valve 108 and/or to optionally provide a valve closing signal 144 for closing of the valve 108 to the valve 108. This means that the electric motor 118 does not move the steering arm 122 when the valve 108 is open. Conversely, this means that the valve 108 blocks a flow of working medium through the valve 108 when the valve 108 is closed, so that according to this exemplary embodiment the working medium is pumped through the transmission device 106 and transmits a steering direction 146 specified by the driver of the vehicle 100 to vehicle wheels 150 by way of a steering rod 148.

According to this exemplary embodiment, the input shaft 120 is configured, for example, to introduce into the steering apparatus 102 a torque from a steering column (not shown), to which the input shaft 120 can be connected or is connected, of the vehicle 100. The torque introduced by way of the input shaft 120 can also be referred to as an input torque. According to this exemplary embodiment, the input shaft 120 is connected, or mechanically coupled, by way of the steering column of the steering system to a steering wheel (not shown) of the vehicle 100. The output shaft 124 is configured according to this exemplary embodiment to guide the torque out of the steering apparatus 102, or to output the torque to the steering arm 122. The torque guided out by way of the output shaft 124 can also be referred to as an output torque or output force. According to this exemplary embodiment, the transmission element 130 is configured to transmit the torque mechanically from the input shaft 120 to the output shaft 124 and/or to convert the input torque into the output torque.

According to this exemplary embodiment, the controller 110 can optionally activate the electric motor 118 in response to a temperature signal 152 which indicates a temperature that is below a threshold value. The temperature signal 152 is provided to the controller 110 according to this exemplary embodiment by a temperature sensor 154, such as, for example, a thermometer. According to this exemplary embodiment, the temperature sensor 154 is or can be in the form of part of the pump device 104. Alternatively, the temperature sensor 154 can also be arranged elsewhere in the vehicle 100. Optionally, the pump device 104 further has an input port 156 by way of which the pump device 104 is connected according to this exemplary embodiment to a storage vessel 158 for storing the working medium.

In other words, a hydraulic pump having an electric motor without a motor bearing is provided. This means that the transmission device 106, which is also referred to as a steering gear, is controlled according to this exemplary embodiment by way of the bidirectionally operating pump 112. To that end, the pump device 104 is connected to at least one cylinder of a conventional known transmission device 106. According to this exemplary embodiment, the electric motor 118 driving the pump 112 is as compact as possible in order, for example, to be used in a serial solution with a solution approach that is as inexpensive as possible.

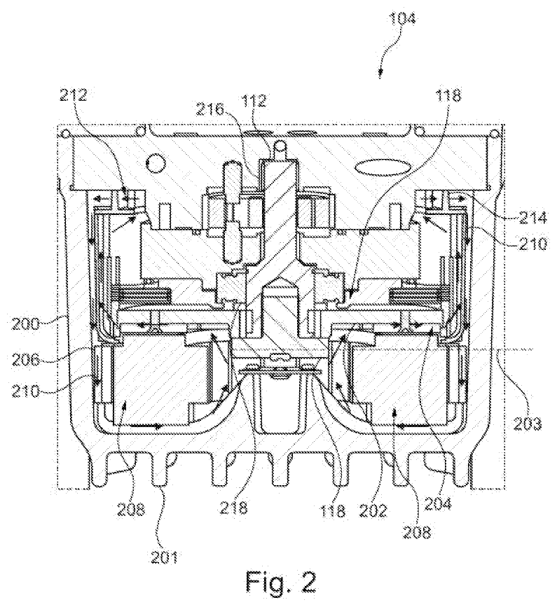

FIG. 2 shows a schematic cross-sectional representation of a pump device 104 according to an exemplary embodiment. The pump device 104 shown here can be similar or correspond to the pump device 104 described in FIG. 1. According to this exemplary embodiment, the pump 112 is arranged centrally in the pump device 104 and is fixedly connected to the electric motor 118. The pump 112 and the electric motor 118 are arranged in a common housing 200 which surrounds both components. According to this exemplary embodiment, the housing 200 has on an outside wall a plurality of fins 201 which are configured to enhance a cooling effect. They are consequently configured to improve an enlargement of a surface of the housing 200 in order to transmit the heat to the surrounding area. The pump 112 and the electric motor 118 further have a common shaft. On a side facing the electric motor 118, the pump 112 is connected in the manner of a cover to a T-shaped coupling point of the electric motor 118. At this coupling point, a rotor 202 of the electric motor 118 is arranged on an axis 203 oriented perpendicular to the pump 112. According to this exemplary embodiment, the rotor 202 in turn has a plurality of permanent magnets, wherein mutually adjacent permanent magnets are spaced apart by slots 204 for the passage of the working medium. The slots 204 are formed to convey the working medium on rotation of the rotor. According to this exemplary embodiment, the housing 200 has a channel 206 for guiding the working medium from an inlet along an inside wall of the housing 200 to a motor winding 208 (not shown) of the electric motor 118. The channel 206 is formed to guide the working medium around the motor winding 208. A direction of flow of the working medium is illustrated by the arrows 210 which are shown. According to this exemplary embodiment, it is thereby likewise illustrated that the motor winding 208 is surrounded by the working medium in order to permit, for example, good heat coupling. In summary, the pump 112 pumps the working medium, starting from a pump outlet 212, through the channel 206 along a wall of the housing 200, where the working medium cools according to one exemplary embodiment, in the direction toward the motor windings 208. From there, the working medium flows according to this exemplary embodiment around the motor winding 208 and through the slots 204, which act as a recirculating pump, in the direction toward the housing wall as far as the pump outlet 212 through, for example, a heat exchanger 214. According to this exemplary embodiment, the pump device 104 has on the side of the pump 112 a needle bearing 216 between the pump 112 and the housing 200. The pump device 104 further has on the side of the electric motor 118 a ball bearing 218.

In other words, the approach presented here makes it possible to dispense with a plurality of motor bearings as well as with a shaft coupling (radial compensation) which was hitherto necessary. Instead, at least a pump bearing can jointly be used. As a result, weight, costs and installation space are saved. This means that the smaller housing 200 can better be installed in the vehicle.

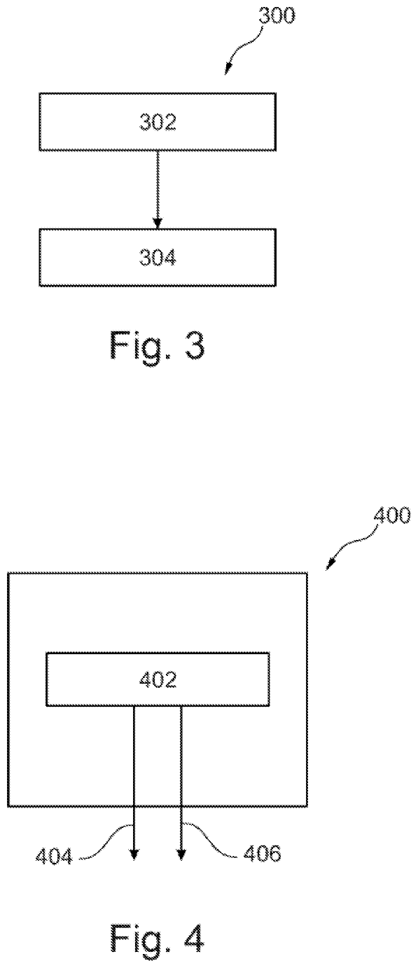

FIG. 3 shows a flow diagram of a method 300 for producing a pump device according to an exemplary embodiment. The pump device produced by the method 300 can correspond to the pump device described in FIG. 1 or 2. The method 300 comprises a step 302 of providing a pump, an electric motor and a housing, and a step 304 of assembling the pump, the electric motor and the housing to produce the pump device.

The method steps presented here can be repeated and can also be carried out in a different order to that described.

FIG. 4 shows a block diagram of an apparatus 400 for activating a method for producing a pump device according to an exemplary embodiment. The apparatus 400 is configured to carry out a method as has been described in FIG. 3 for producing a pump device. The apparatus 400 has a provision unit 402 which is configured to provide a provision signal 404 and an assembly signal 406.

If an exemplary embodiment includes an “and/or” conjunction between a first feature and a second feature, this is to be interpreted as meaning that the exemplary embodiment according to one embodiment has both the first feature and the second feature and according to a further embodiment has either only the first feature or only the second feature.

### LIST OF REFERENCE SIGNS

100 vehicle
102 steering apparatus
104 pump device
106 transmission device
108 valve
110 controller
112 pump
114 first output port
116 second output port
118 electric motor
120 input shaft
122 steering arm
124 output shaft
126 first direction
128 second direction
130 transmission element
132 first working medium port
134 second working medium port
136 first valve port
138 second valve port
140 motor signal
142 valve opening signal
144 valve closing signal
146 steering direction
148 steering rod
150 vehicle wheels
152 temperature signal
154 temperature sensor
156 input port
158 storage vessel
200 housing
201 fins
202 rotor
203 axis
204 slot
206 channel
208 motor winding
210 arrow
212 pump outlet
214 heat exchanger
216 needle bearing
218 ball bearing
300 method
302 step of providing
304 step of assembling
400 apparatus
402 provision unit
404 provision signal
406 assembly signal

1.-15. (canceled)

16. A pump device for a steering apparatus of a vehicle, comprising:
a pump for pumping a working medium to a first output port or alternatively to a second output port;
an electric motor for driving the pump; and
a housing through which the first output port and the second output port are guided and which is arranged around both the pump and the electric motor.

17. The pump device as claimed in claim 16, wherein
the pump is arranged with the electric motor on a common shaft.

18. The pump device as claimed in claim 16, wherein
the electric motor has a rotor with a plurality of permanent magnets, and
mutually adjacent ones of the plurality of permanent magnets are spaced apart by slots for passage of the working medium.

19. The pump device as claimed in claim 18, wherein
the slots are formed so as to convey the working medium on rotation of the rotor.

20. The pump device as claimed in claim 16, wherein
the electric motor has a motor winding which is surrounded by the working medium.

21. The pump device as claimed in claim 20, wherein
the housing has a channel for guiding the working medium from an inlet along an inside wall of the housing to the motor winding, and
the channel is formed to guide the working medium around the motor winding.

22. The pump device as claimed in claim 16, wherein
on a side of the pump, a needle bearing is arranged between the pump and the housing, and/or
on a side of the electric motor, a ball bearing is provided.

23. The pump device as claimed in claim 16, wherein
the electric motor is a disk motor.

24. The pump device as claimed in claim 16, wherein
the pump is a bidirectional hydraulic pump.

25. A steering apparatus for a vehicle, comprising:
a pump device comprising:
a pump for pumping a working medium to a first output port or alternatively to a second output port;
an electric motor for driving the pump; and
a housing through which the first output port and the second output port are guided and which is arranged around both the pump and the electric motor;
a transmission comprising:
an input shaft, which is couplable with a steering wheel, and
an output shaft, which is couplable with a steering arm,
a transmission element which is movable in a first direction and in a second direction in order to transmit a torque from the input shaft to the output shaft, and
a first working medium port and a second working medium port, wherein
the first working medium port is connected to the first output port for moving the transmission element in the first direction using the working medium, and
the second working medium port is connected to the second output port for moving the transmission element in the second direction using the working medium; and
a controller configured to provide a motor signal to the electric motor in order to operate the electric motor of the steering apparatus.

26. The steering apparatus as claimed in claim 25, further comprising:
a valve which is connected between the first output port and the second output port.

27. A method for producing a pump device, comprising:
providing a pump, an electric motor and a housing; and
assembling the pump, the electric motor and the housing to produce the pump device, wherein the produced pump device comprises:
the pump for pumping a working medium to a first output port or alternatively to a second output port;
the electric motor for driving the pump; and
the housing through which the first output port and the second output port are guided and which is arranged around both the pump and the electric motor.
